(19) United States
(12) Patent Application Publication
(10) Pub. No.: US 2025/0382395 A1
(43) Pub. Date: Dec. 18, 2025

(54) Polyisobutylene Epoxide, its Preparation and Use

(71) Applicant: TPC Group LLC, Houston, TX (US)

(72) Inventors: Tim J. Coffy, Houston, TX (US); Wayne Ouellette, Missouri City, TX (US); Joseph G Duff, League City, TX (US)

(21) Appl. No.: 18/741,008

(22) Filed: Jun. 12, 2024

(51) Int. Cl. C08F 8/08

(52) U.S. Cl. CPC C08F 8/08

(57) ABSTRACT

The invention relates to a new and improved process for making an epoxidized olefin, specifically, polyisobutylene epoxide. The inventive process generally comprises (a) combining a polyisobutylene and a solvent to form a first mixture, (b) combining a peroxide, a carboxylic acid and an acid catalyst to form a second mixture, (c) reacting the first and second mixtures forming a non-aqueous phase comprising a polyisobutylene epoxide and an aqueous phase; (d) separating the non-aqueous phase from the aqueous phase; (d) washing and neutralizing the non-aqueous phase, and (e) recovering in a high yield and high purity polyisobutylene epoxide. It was discovered that specific mole ratios and amounts of reactants provide for recovering in high yield and purity polyisobutylene epoxide with reduced detrimental by-products.

### FIELD OF THE INVENTION

The invention relates to epoxidized polyisobutylene, their production and use. In particular the invention is directed to a process for epoxidizing isobutene polymers, or preferably polymers with unsaturation. More specifically, the invention is directed to a new and improved process for making epoxidized polyisobutylene compounds, for use as an intermediate for making polyisobutylene compound, specifically polyisobutylene alcohol amine, derivatives and compositions thereof. The resulting polyisobutylene compounds, derivatives and compositions thereof are useful in applications such as lubricants, surfactants, emulsifiers, resins, and the like.

### BACKGROUND OF THE INVENTION

Epoxidation of a broad variety of alkenes, including polymers with double bonds, is known in the art. Representative prior art showing various procedures for epoxidizing a number of types of unsaturated materials include the following: Song et al., J. Polym. Sci. Polym. Chem. Vol. 40, pp. 1484-1497 (2002); Shigenobu et al. (Maruzen Petrochemical); JP Patent Application No. JP2001 031716A, published Feb. 26, 2001; Suzuki et al., Journal of Applied Polymer Science, Vol. 72, pp. 103-108 (1999); and Li et al.: Macromolecules, Vol. 38, pp. 6767-6769 (2005).

Epoxidation of non-polymeric materials using catalysts or selected reaction medium solvents is also known in the art. Representative prior art references showing these kinds of epoxidation includes Hellmann et al., Angew Chem. Int. Ed. Engl. Vol. 30, No. 12, pp. 1638-1641 (1991); Van Vliet et al., Chem. Commun., pp. 821-822, (1999); and Neimann et al., Org. Letters, Vol. 2, No. 18, pp. 2861-2863 (2000). includes Hafren et al., Macromol. Rapid Commun., Vol. 26, pp. 82-86 (2005); Song et al., J. Polym. Sci. Polym. Chem. Vol. 40, pp. 1484-1497 (2002); Shigenobu et al. (Maruzen Petrochemical); Japanese Patent Application. No. JP2001 031716A, published Feb. 26, 2001; Suzuki et al., Journal of Applied Polymer Science, Vol. 72, pp. 103-108 (1999); and Li et al.: Macromolecules, Vol. 38, pp. 6767-6769 (2005).

U.S. Pat. No. 3,382,255 generally discusses epoxidizing olefinic polymers using peroxy-organic acids (ex: peracetic and perphthalic) to form epoxidized olefinic polymers in relatively good yields. U.S. Pat. No. 3,360,531 generally discusses epoxidizing unsaturated fatty compounds, such as a fatty glyceride, using a mixture of aqueous hydrogen peroxide with acetic acid in the presence of a liquid acid. U.S. Pat. No. 3,794,586 generally discusses epoxidizing olefinic polymers using peroxy-organic acids (ex: peracetic) to form epoxidized olefinic polymers. U.S. Pat. No. 3,794,586 generally discusses epoxidizing olefinic polymers using peroxy-organic acids (ex: peracetic) to form epoxidized olefinic polymers. U.S. Pat. No. 6,448,418 B1 describes the process for the epoxidation of olefinic polymers, using a mixture of aqueous hydrogen peroxide with formic acid. The process described in US'418 is specific to the use of formic acid. U.S. Pat. No. 7,741,410 describes the process for the epoxidation of olefinic polymers, using an aqueous phase comprising formic acid and hydrogen peroxide. The process can contain acetic acid as a mediator, but it teaches that the formic acid in reaction with the peroxide serves to peroxidize the olefin.

While much information is available on the epoxidation of polyisobutylene, problems remain with the process wherein impurities and byproducts are formed during the reaction which are difficult to remove, resulting in low epoxide yield and purity. Byproducts formed during the reaction include for example, diols, aldehydes and alcohols which are difficult to impossible to remove from the desired polyisobutylene epoxide. Accordingly, none of the above patents refer to reaction conditions to obtain high olefin conversion (defined herein to mean the mole percent of olefins consumed in the reaction as measured by ¹H-NMR) and high epoxide yield (defined herein to mean the mole percent of epoxide moiety contained in the final product as measured by ¹H-NMR) of the desired epoxide. The specific relevance of the carboxylic acid/olefin mole ratio or the peroxide/olefin mole ratio for producing a polyisobutylene epoxide in high olefin conversion and epoxide yield is not discussed.

U.S. patent application Ser. No. 18/509,797, filed on Nov. 15, 2023, which has been fully incorporated by reference for U.S. purposes discusses using a polyisobutylene epoxide (PIB epoxide) for making a bis-polyisobutylene amino alcohol. However, there is no discussion or process for making the polyisobutylene epoxide.

While the epoxidation of polyisobutylene is known, there is no disclosure or exemplification in the above discussed references that provide for a process of making a polyisobutylene epoxide using the same reactant combinations, reaction conditions or mole ratio of reactants as the present invention.

A need continues to exist in the art for new and improved process for making polyisobutylene epoxides with higher olefin conversion and increased epoxide yield. There is also a need in the art for a new and improved process for making polyisobutylene epoxides requiring less purification and separation steps.

### SUMMARY OF INVENTION

Disclosed herein is a process for making a polyisobutylene epoxide, the process comprising the steps of (a) reacting in a reactor vessel polyisobutylene olefin with (i) a diluent or solvent capable of solubilizing the polyisobutylene, (ii) a peroxide (iii) a carboxylic acid, and (iv) an acid catalyst, to form a mixture, (b) reacting the mixture for a time sufficient to form a non-aqueous phase comprising the polyisobutylene epoxide and an aqueous phase; (c) separating the non-aqueous phase from the aqueous phase; (d) washing the non-aqueous phase comprising the polyisobutylene epoxide, (e) neutralizing the non-aqueous phase comprising the polyisobutylene epoxide, and (e) isolating and drying the polyisobutylene epoxide, wherein the mole ratio of peroxide/polyisobutylene or peroxide/olefin is from about 1 to about 7, the carboxylic acid/polyisobutylene or carboxylic acid/olefin mole ratio is from about 0.5 to about 3, and the weight percent catalyst is greater than 1 wt %, preferably greater than 2 wt %, and most preferably greater than 3 wt % as defined in this patent specification.

In one embodiment, the process of the invention is directed to a process for making an olefin polymer epoxide, preferably a polyisobutylene epoxide, the process comprising the steps of (a) contacting in a reactor vessel, preferably a single reactor vessel, polyisobutylene olefin with (i) a diluent or solvent, preferably a solvent capable of solubilizing the polyisobutylene, (ii) a peroxide, preferably hydrogen peroxide, (iii) a carboxylic acid, preferably acetic acid, and (iv) an acid catalyst, preferably sulfuric acid, forming a reaction mixture of a non-aqueous phase and an aqueous phase (b) reacting the reaction mixture for a time sufficient to form the polyisobutylene epoxide in primarily the non-aqueous layer (c) separating the non-aqueous phase from the aqueous phase; (d) washing the non-aqueous phase comprising the polyisobutylene epoxide with preferably water for a time sufficient to remove substantially all the unreacted and remaining carboxylic acid and acid catalyst and (e) neutralizing the non-aqueous phase comprising the polyisobutylene epoxide with a neutralizing agent, in particularly a dilute aqueous sodium bicarbonate solution for reducing pH, and (f) isolating and drying the polyisobutylene epoxide wherein ¹H-NMR indicates an olefin conversion of greater than 90%, preferably greater than 93% and most preferably greater than 95%, and an epoxide yield of greater than 90%, preferably greater than 93%, and most preferably greater than 95%, of the desired polyisobutylene epoxide.

In one embodiment of the above inventive process, the mole ratio of peroxide/polyisobutylene (referred also to as peroxide/olefin mole ratio where the olefin is referring to the double bond contained within the polyisobutylene) is from greater than 1 to about 7, preferably from about 1.5 to less than 7, more preferably from about 1.5 to about 6, and most preferably from about 2 to about 6. The calculation of mole ratios is known by someone of ordinary skill in the art. Herein, the moles of olefins used in the peroxide/olefin and carboxylic acid/olefin mole ratios are each calculated based on the number average molecular weight (Mn) of the polyisobutylene. In these mole ratios, the moles of olefin are calculated by dividing the actual weight of the polyisobutylene used by the Mn of the polyisobutylene; the moles polyisobutylene calculated are same as the moles of olefin because polyisobutylene has only one double bond.

In another embodiment of the process of the invention, the mole ratio of the carboxylic acid/polyisobutylene (carboxylic acid/olefin) as described above is from about 0.5 to about 4, more preferably from greater than 0.5 to less than 4, and even more preferably from 0.75 to less than 3, and most preferably from 1 to about 2.5.

In one embodiment of the process above, the pH of the aqueous phase after the neutralization step (e) is in the range from about 6 to 8, more preferably from about 6.5 to about 7.5, and most preferably about 7.

In one embodiment of the process above, the washing step (d) and neutralization step (e) are performed sequentially, simultaneously, or alternatively. In a preferred embodiment, the washing step (d) is performed first, one, two or three times prior to the neutralization step (e).

In yet another embodiment the process of the invention is directed to a process for making a polyisobutylene epoxide, the process comprising the steps of (a) introducing a polyisobutylene olefin and a diluent or solvent forming a first mixture in a reactor vessel (b) forming a second mixture comprising a peroxide, a carboxylic acid, and an acid catalyst; (c) introducing the second mixture to the first mixture in the reactor vessel; (d) reacting, with or without agitation, preferably with agitation, the first and second mixtures for a sufficient amount of time and temperature for forming a non-aqueous phase comprising the polyisobutylene epoxide and an aqueous phase; (e) separating the non-aqueous phase from the aqueous phase forming a separated non-aqueous phase; (f) washing the separated non-aqueous phase to form a washed and separated non-aqueous phase; (g) neutralizing the washed and separated non-aqueous phase forming a neutralized, washed and separated non-aqueous phase; and (h) recovering from the neutralized, washed and separated non-aqueous phase a purified polyisobutylene epoxide.

In this embodiment, in the introducing step (c) of the second mixture (a mostly aqueous solution) to the first mixture (polyisobutylene and solvent mixture) the temperature in the reactor vessel is maintained at no more than about 15° C., to, preferably less than 10° C., above a reactor temperature, which is typically an ambient reactor temperature.

Furthermore, in this embodiment, the washing step (f) and neutralization step (g) are repeated as many times as required to attain a pH of the purified polyisobutylene epoxide of about 6.5 to about 7.5, most preferably about 7.

Also, in this embodiment, the reaction vessel temperature in step (d) is increased within the range of from about 50° C. to 80° C., preferably about 60° C. to 75° C., and most preferably about 65° C. to 70° C.

In a preferred embodiment of the process, the resulting purified polyisobutylene epoxide indicates a greater than 93% olefin conversion and a greater than 93% epoxide yield as measured by ¹H-NMR.

In yet another preferred embodiment of any of the above processes of the invention, wherein the polyisobutylene has an Mn of from about 400 to about 1500, preferably about 400 to about 1200, and more preferably about 450 to about 1200, the peroxide/olefin mole ratio is from about 2.5 to about 3.5, the carboxylic acid/olefin mole ratio is from about 1 to about 1.5, and the amount of acid catalyst in the aqueous phase is from about 4 wt % to about 8 wt %.

In another preferred embodiment of any of the above processes of the invention, wherein the polyisobutylene has a Mn of from about 1500 to about 5000, preferably from 1500 to 3000, the peroxide/olefin mole ratio is about 5 to about 6, the carboxylic acid mole ratio is from about 2 to about 2.5, and the amount of acid catalyst is from 4 wt % to about 6 wt %.

In another embodiment of the process of the invention, the polyisobutylene epoxide comprises an epoxidized highly reactive polyisobutylene having between 60 mole percent to about 90 mole percent alpha-vinylidene isobutylene isomer content.

In yet another embodiment, the invention is directed to a process for epoxidizing polyisobutylene, the process comprising the steps of:

(a) combining in a single reactor vessel at ambient temperature and pressure, polyisobutylene having a number average molecular weight (Mn) in the range of about 400 to about 2500 and a solvent capable of solubilizing the polyisobutylene, (b) adding, without, preferably with an agitator, to the single reactor vessel a mixture of reactants comprising a hydrogen peroxide, an organic carboxylic acid and a mineral acid catalyst while maintaining a reactor temperature at no more than 15° C., preferably at more than about 10° C., above ambient temperature, wherein the hydrogen peroxide/olefin mole ratio is from about 1.5 to about 7.0, the carboxylic acid/olefin mole ratio is from about 0.5 to about 3.0, and the acid catalyst is present in amount of from about greater than 2 wt % to about 10 wt %, preferably from about 3 wt % to about 6 wt %; (c) heating the single reactor vessel to no more than 80° C. for a time sufficient to form a non-aqueous phase comprising polyisobutylene epoxide and an aqueous phase; (d) cooling the single reactor vessel, preferably to about 45° C. to about 50° C., to sufficiently separate the non-aqueous phase from the aqueous phase; (e) washing and neutralizing the non-aqueous phase to sufficiently remove and neutralize substantially all the acid remaining in the non-aqueous phase; and (f) isolating and drying the polyisobutylene epoxide wherein ¹H-NMR analysis indicates an olefin conversion of at least 90% and an epoxide yield of at least 90%.

In this embodiment, after the washing and neutralization step (e) the non-aqueous phase has a pH of about 6.5 to about 7.5, preferably about 7.

In yet another embodiment of the process above, after step (b), in step (c), the reactor vessel is heated to about 70° C. for about 2 to 3 hours.

### DETAILED DESCRIPTION OF EMBODIMENTS

It was found that the process of the invention for epoxidizing polyisobutylene to form polyisobutylene epoxide (referred to herein as PIB epoxide. “Epoxide” herein refers to polyisobutylene epoxide; and “olefin” herein refers to the polyisobutylene. The inventive process provides for a unique combination of peroxide, carboxylic acid, and acid catalyst that when controlled within a specific range produces the desired polyisobutylene epoxide (PIB epoxide) in high olefin conversion and high epoxide yield. The PIB epoxide made using the inventive process of the invention are generally produced with greater than 90% for both olefin conversion and epoxide yield, often greater than 93%, and even greater than 95%. It was surprisingly found that the reaction conditions for the process of the invention are dependent on the number average molecular weight (Mn) and the reactant mole ratios. More specifically, it was surprisingly found in one embodiment of the process of the invention that doubling the oxidizing reactants, the peroxide/olefin and carboxylic/olefin, mole ratios while maintaining a consistent percentage of an acid catalyst, a higher olefin conversion and epoxide yield is achievable when using a higher Mn polyisobutylene. While not wanted to be bound by any particular theory, it is believed that this is because the lower concentration of double bonds in the higher Mn polyisobutylene as opposed to the lower Mn polyisobutylene. Also, the longer chains in the higher Mn polyisobutylene reduce the likelihood of epoxidation because of the more hydrophobic nature of the higher Mn, and thus, requires the use of a higher mole ratio of oxidants to push the conversion to PIB epoxide. Accordingly, the present invention is directed to a process of making polyisobutylene epoxide with a high olefin conversion and high epoxide yield. Various embodiments of the present invention will be described below.

During the inventive process for making polyisobutylene epoxide it was surprisingly discovered that there are preferred reactant amounts and ranges that lead to higher yields and higher purity polyisobutylene epoxide. Thus, in doing so, byproducts due to over oxidation, such as alcohols, ketones, and aldehydes are avoided. These byproducts cannot be easily or readily separated from the desired final PIB epoxide product. These overoxidized byproducts do not provide the desired reactivity as does the epoxide and will essentially “waste” or “underutilize” the polyisobutylene starting material. Therefore, the invention is directed to a process that provides a high epoxide yield of the desired polyisobutylene epoxide while minimizing these side reactions, and this is accomplished by employing the reactant conditions disclosed.

### Polyisobutylene

The polyisobutylene epoxide product made by the inventive process of the invention is obtained by oxidizing a polyalkene with an oxidizing agent to give an alkylene oxide, or epoxide, in which the oxirane ring is derived from oxidation of the double bond in the polyalkene. A preferred polyalkene is polyisobutylene.

Polyisobutylene (PIB) is a long chain molecule synthesized by polymerizing or linking isobutylene molecules. There are many processes well known in the art for making PIB including but not limited to U.S. Pat. Nos. 9,598,655, 9,617,363, 9,309,339, 6,562, 913, 8,524,843, 8,946,361, 11,326,004, 9,074,026 and 9,809,665 and EP1381637B2, which are all fully incorporated by reference.

PIB comes in many forms with a wide range of molecular weights from a few hundred to a few million, typically the preferred use number average molecular weight (Mn) is in the range of from 300 to 5000, preferably 400 to 4000 and most preferably around 450 to about 3500 or less.

In one embodiment of the process of the invention, the polyisobutylene has a number average molecular weight (Mn) of from about 300 to 5000, preferably from 350 to 4000, more preferably from about 400 to about 3500, even more preferably from about 450 to about 3000, most preferably from about 450 to about 2500.

In one embodiment of the process of the invention, the polyisobutylene has a number average molecular weight (Mn) of from about 300 to 1500, preferably from about 350 to about 1400, more preferably from about 400 to about 1300, most preferably from 450 to 1200.

In one embodiment of the process of the invention, the polyisobutylene has a number average molecular weight (Mn) of from about 1500 to 5000, preferably from about 1600 to about 4000, more preferably from about 1800 to about 3000, most preferably from 2000 to about 2500.

In one embodiment of the process of the invention, the polyisobutylene epoxide has a number average molecular weight (Mn) of from about 400 to about 5000 and oxirane oxygen value of 3.2% to about 0.15%, more preferably an Mn of from about 400 to about 3000 and an oxirane oxygen value of from about 3.2% to about 0.2%, and most preferably an Mn of from about 450 to about 2500 and an oxirane oxygen value of from about 2.7 to about 0.25%.

In addition, PIB as a result of the differing chain lengths also having a wide range of polydispersity index (PDI), measured by GPC using polyisobutylene standards, typically in the range of from about 1.1 to less than 4, more preferably from 1.3 to less than 4, and most preferably from about 1.4 to less than 3. Together the Mn and PDI are key properties for determining useful PIB viscosities and flash points for specific uses.

PIB is available from many commercial manufactures such as TPC Group, INEOS Oligomers, Infineum, Lubrizol and BASF, each supplying various combinations of low, medium and highly reactive PIB such as GLISSOPAL® and OPPANOL® from BASF Corporation, Ludwigshafen, Germany, Indopol® products available from INEOS Oligomers, London, UK, LUBRIZOL 3108 available from The Lubrizol Corporation, Wickliffe Ohio.

Several types of PIB are available from TPC Group, Houston, TX including highly reactive PIB (HR-PIB) such as HR 545, HR595 and HR 5230, medium reactive PIB (LM-PIB) such as TPC 175 and TPC 1160 and di-isobutylene (DIB) and tri-isobutylene (TIB).

The determining factor for differentiating between medium and highly reactive PIB is the concentration of various double bond end group types, i.e., alpha, beta, tetrasubstituted, trisubstituted, and substituted alpha among others. The difference between the PIB can be determined by measuring the PIB alpha-vinylidene content. Conventional or low to medium have between 0 and 10% alpha-vinylidene isobutylene isomer content, whereas highly reactive PIB has between 50% to 90% or greater alpha-vinylidene isobutylene isomer content.

### Diluent or Solvent

Due to the high viscosity of the starting olefins, namely polyisobutylene's discussed above, the epoxidation reaction is desirably carried out in a diluent or solvent, preferably a hydrocarbon solvent. The purpose of the diluent or solvent is to essentially reduce the viscosity of the polyisobutylene for use in the process of the invention for making the polyisobutylene epoxide. The solvent can also help the reaction vessel maintain the desired temperature. In one embodiment, suitable hydrocarbon solvents are used in combination with polyisobutylene to form a two-phase reaction system with the epoxidizing reagents comprising of an aqueous hydrogen peroxide solution, a carboxylic acid such as acetic acid, and an acid catalyst such as sulfuric acid. The solvents are immiscible with water or possess extremely limited miscibility.

The hydrocarbon solvents are used in an amount appropriate for the formation of an organic, non-aqueous, phase that can be separated from the aqueous phase. Additionally, the hydrocarbon solvents or diluents can be any organic solvent or combination of solvents or diluents that are inert toward the reactants (hydrogen peroxide, carboxylic acids, etc.) and the final epoxide, i.e., polyisobutylene epoxide, product.

Examples of suitable hydrocarbon solvents are aromatic and aliphatic hydrocarbons such as benzene, toluene, xylenes, ethylbenzene, pentanes, hexanes, heptane, octanes, cyclopentane, cyclohexane, methyl-cyclopentane, methylcyclohexane. Solvents are preferred that do not form stable emulsions with the water phase and further which will separate reasonably quickly from the non-aqueous phase. Non-aromatic solvents are preferred with hexanes being the most preferred. The weight ratio of solvent or diluent to olefin, namely polyisobutylene, generally ranges from 20:1 to 1:5 and preferably from 10:1 to 1:2. Most preferred solvents for the present invention include hexane and heptane.

### Peroxides

In the most preferred embodiment, the peroxide is hydrogen peroxide. Hydrogen peroxide typically contains water and is an aqueous solution. In one embodiment, the aqueous solution of hydrogen peroxide in water is about 10% to about 70%, preferably in the range of from 30% to about 60%, and the most preferably range of from about 45% to about 55%.

In one embodiment of the above process, the mole ratio of peroxide/polyisobutylene (sometimes referred to as peroxide/olefin where the olefin is referring to the double bond contained within the polyisobutylene) is from greater than 1 to about 7, preferably from about 1.5 to less than 7, more preferably from about 1.5 to about 6, and most preferably from about 2 to about 6 based on the number average molecular weight of the polyisobutylene.

Where the number average molecular weight of the polyisobutylene is from about 400 to 5000, the mole ratio of peroxide/olefin is from 1 to about 7, where PIB has an Mn of from 425 to 4000, the mole ratio of peroxide/olefin is from 1.5 to about 7, where PIB has a Mn of from about 450 to about 3000, the mole ratio of peroxide/olefin is from 2 to about 6, where PIB has a Mn from about 450 to about 2500, the mole ratio of peroxide/olefin is from 2 to about 6, and where PIB has an Mn of from about 450 to about 2500, the mole ratio of peroxide/olefin is from 2 to about 6.

In one embodiment of the process of the invention, the polyisobutylene has a number average molecular weight of from about 300 to 1500, the mole ratio of peroxide/olefin is from 1 to about 5, preferably where the Mn of PIB is from about 350 to about 1400, the mole ratio of peroxide/olefin is from more than 1 to about 4, more preferably where the Mn of PIB is from about 400 to about 1300, the mole ratio of peroxide/olefin is from more than 2 to less than 4, most preferably where the Mn of PIB is from 450 to 1200, the mole ratio of peroxide/olefin is from 2.5 to 3.5.

In one embodiment of the process of the invention, the polyisobutylene has a number average molecular weight of from about 1500 to 5000, the mole ratio of peroxide/olefin is from 3 to 7, preferably where the Mn is from about 1600 to about 4000, the mole ratio of peroxide/olefin is from 3.5 to less than 7, more preferably where the Mn of PIB is from about 1800 to about 3000, the mole ratio of peroxide/olefin is from 4 to about 6, most preferably where the Mn of PIB is from 2000 to about 2500, the mole ratio of peroxide/olefin is from 5 to 6.

### Carboxylic Acid

There are many types of carboxylic acids that are useful in the process of the invention for making polyisobutylene epoxide. Non-limiting examples of useful carboxylic acids include formic acid, acetic acid, trichloro acetic acid, trifluoro acetic acid, propionic acid, benzoic acid, m-chloro-benzoic acid, and the like. The carboxylic acid tends to have an affinity for the aqueous phase, so it is easily washed out of the reaction mixture. Regardless, the organic acid must be suitable to form a peroxy-carboxylic acid in the aqueous phase when reacting with the peroxide and assisted by the acid catalyst.

The general range of carboxylic acid, preferably acetic acid/olefin mole ratio is from about 0.5 to about 4, more preferably from greater than 0.5 to less than 4, and even more preferably from 0.75 to less than 3, and most preferably from 1 to about 2.5.

In a preferred embodiment of any of the above embodiment, where the polyisobutylene has a Mn of from about 400 to about 1200, the peroxide/olefin mole ratio is from about 2.5 to about 3.5, the carboxylic acid/olefin mole ratio is from about 1 to about 1.5, and the amount of acid catalyst in the aqueous phase is from about 4 wt % to about 6 wt %.

In the most preferred embodiment, the carboxylic acid is an organic carboxylic acid such as acetic acid, preferably glacial acetic acid. In one embodiment of the process of the invention, when the polyisobutylene has a number average molecular weight of from about 300 to 1500 the carboxylic acid/olefin mole ratio is generally from about 0.5 to about 2.5, preferably where the Mn of PIB is from about 350 to about 1400, the carboxylic acid/olefin mole ratio is generally from about 0.5 to about 2.0, more preferably, where the Mn of PIB is from about 400 to about 1300 the carboxylic acid/olefin mole ratio is generally from about 0.75 to about 1.5, most preferably where the Mn of PIB is from 450 to 1200, the carboxylic acid/olefin mole ratio is generally from about 1 to about 1.5.

In another embodiment of the process of the invention, where the number average molecular weight of the polyisobutylene is from about 1500 to 5000, the carboxylic acid/olefin mole ratio is generally from about 1 to about 4.0, preferably where the Mn of PIB is from about 1600 to about 4000, the carboxylic acid/olefin mole ratio is generally from about 1.5 to about less than 4.0, more preferably where the Mn of PIB is from about 1800 to about 3000, the carboxylic acid/olefin mole ratio is generally from about 2 to about 3, most preferably where the Mn of PIB is from 2000 to about 2500, the carboxylic acid/olefin mole ratio is generally from about 2 to about 2.5.

In yet a further embodiment, the lower end of the carboxylic acid/olefin mole ratio is 0.5, preferably 0.60, more preferably 0.70, and most preferably about 0.8 or about 0.9.

### Catalyst

There are many types of catalysts, particularly acid catalysts, especially mineral acid catalysts, that are useful in the process of the invention of making a polyisobutylene epoxide. Non-limiting examples of useful acid catalysts include sulfuric acid, phosphoric acid, nitric acid, hydrochloric acid, and the like. In the most preferred embodiment of the process of making the polyisobutylene, the preferred acid catalyst is sulfuric acid.

The weight percent of acid catalyst used in the inventive process is greater than 1 wt %, preferably greater than 1.5 wt %, and more preferably greater than 2 wt %. In another embodiment, the weight percent catalyst used in the inventive process is preferably in the range of from 2 wt % to 20 wt %, preferably greater than 2 wt % to 18 wt %, more preferably 3 wt % to 10 wt %, and most preferably 4 wt % to about 6 wt %.

The weight percent (wt %) acid catalyst for purposes of this patent specification and appended claims is defined to be based on the actual weight of the acid catalyst divided by the sum of the weights of the peroxide, carboxylic acid and acid catalyst, multiplied by 100.

The weight percent acid catalyst is relevant in driving the reaction to completion, and it will be appreciated that while preferred ranges are provided, it is preferred to use only so much as necessary to avoid more complex and time consuming washing and neutralization steps discussed below.

The non-aqueous phase results from the reaction mixture of polyisobutylene, solvent or diluent, and the aqueous phase results from the mixture of peroxide, carboxylic acid, and acid catalyst. Mixing the above reagents for each phase results in two phases, a non-aqueous phase and an aqueous phase.

In still yet another preferred embodiment of the process of the invention, the acid catalyst is present in an amount in the range of from greater than 2 wt % to about 20 wt %. In yet another embodiment, the weight percent catalyst present is preferably in the range of from 3 wt % to about 16 wt %, more preferably from 3 wt % to 8 wt %, even more preferably from about 3.5 wt % to about 7 wt %. In some embodiments, the weight percent catalyst used in the inventive process is in the range of from about 5 wt % to about 6 wt %.

In still yet another preferred embodiment, of the above process of the invention, the acid catalyst is used in an amount in the range of from about greater than 2 wt % to about 8 wt %, preferably from about 3.5 wt % to about 7 wt %, more preferably from about 4 wt % to less than 7 wt %, and most preferably from about 4 wt % to about 6 wt %.

### Polyisobutylene Epoxide

There are diverse types of polyisobutylene epoxides produced according to the present invention. The polyisobutylene epoxide produced by the inventive process, referred to as Type 1, 2 or 3 polybutylene epoxides, are represented below:

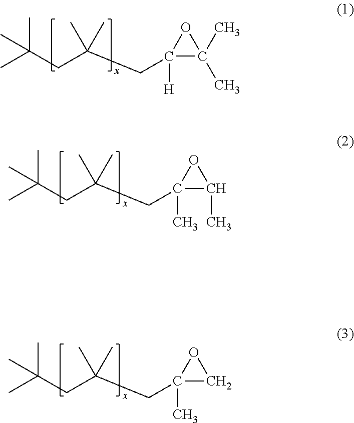

wherein x is from 1 to about 200, preferably 1 to about 100 and most preferably between 1 to 50, and content of polyisobutylene epoxide species bearing Type 1, 2 and/or 3 polyisobutylene epoxides of at least 50 mol %, more preferably 60 mol % and most preferably 80 mol % or greater. In one embodiment of the general formulae above x is 100 and y is an integer from 1 to 10, and in another embodiment, x is 50 and y is 2 to 10. In yet another embodiment, of the general formulae above x is an integer in the range of from 90 to 110 and y is an integer from 1 to 10, and in another embodiment, x is an integer in the range of from 40 to 60 and y is an integer from 2 to 10. It is generally believed that Type 3 epoxides possess high reactivity toward amination, these polyisobutylene epoxides are preferred. However, it has been surprisingly found that epoxides of Type 1 and Type 2 also exhibit reactivity toward amination. Therefore, polyisobutylene epoxides that contain higher amounts of Type 1 and Type 2 epoxy groups are also useful in the present invention. In any case, if Type 3 epoxides are desired, they are produced starting with polyisobutylene containing high concentrations of Type 3 double bonds (shown above).

Type 4 tetra-polyisobutylene epoxide is present as a result of the process for making polyisobutylene epoxide and is present with all other Types 1, 2 and 3 in various amounts. For example, Type 4 is present in highly reactive polyisobutylene epoxide, a Type 3, in an amount of about 1 to less than 5 mol %, more likely between 1 mol % to less than 3 mol %, and in a low to medium reactivity polyisobutylene epoxide, a Type 1 and 2, Type 4 is present in an amount of between 25 mol % to 40 mol % or higher, more likely about 30 mol % to about 40 mol %.

In one embodiment of the process of the invention, the polyisobutylene epoxide has a number average molecular weight of from about 400 to about 5000 and oxirane oxygen value of 3.2% to about 0.15%, more preferably the PIB has a Mn of from about 400 to about 3000 and an oxirane oxygen value of from about 3.2% to about 0.2%, and most preferably the PIB has an Mn of from about 450 to about 2500 and an oxirane oxygen value of from about 2.7 to about 0.25%.

In one embodiment of the process of the invention, the polyisobutylene has a number average molecular weight of from about 300 to 5000, preferably from 350 to 4000, more preferably from about 400 to about 3500, even more preferably from about 450 to about 3000, most preferably from about 450 to about 2500.

In one embodiment of the process of the invention, the polyisobutylene has a number average molecular weight of about 300 to 1500, preferably from about 350 to about 1400, more preferably from about 400 to about 1300, most preferably from 450 to 1200.

In one embodiment of the process of the invention, the polyisobutylene has a number average molecular weight of from about 1500 to 5000, preferably from about 1600 to about 4000, more preferably from about 1800 to about 3000, most preferably from 2000 to about 2500.

In another embodiment of the process of the invention, the PIB epoxide comprises an epoxidated highly reactive polyisobutylene having between 60 mole percent to about 90 mole percent alpha-vinylidene isobutylene isomer content, more preferably having between 65 mole percent to about 85 mole percent alpha-vinylidene isobutylene isomer content, even more preferably having between 70 mole percent to about 85 mole percent alpha-vinylidene isobutylene isomer content, most preferably having between 75 mole percent to about 85 mole percent alpha-vinylidene isobutylene isomer content.

### Process of Making Polyisobutylene Epoxide

The invention is directed to a new and improved process for making an epoxidized olefin, more specifically polyisobutylene epoxide.

Polyisobutylene epoxide is made in one or more reactor(s) or reaction or reactor vessel(s). In the most preferred embodiment, the polyisobutylene epoxide is made in a single, one-pot, reactor or reaction vessel. There are numerous advantages for using a single reactor including reduced capital, process simplicity, less likelihood for contaminants, and improved process control for achieving greater yields and improved purity of the polyisobutylene epoxide made.

### Reaction Conditions

Depending on the reactor type and configuration the reaction conditions may vary as is well known to one of skill in the art. In one embodiment, a batch process is used for making the PIB epoxide using the new and improved process of the invention. The reactor or reaction vessel is preferably jacketed, heated and agitated to a specified temperature and pressure. With respect to the reactants, these are specifically discussed above in detail including preferred amounts and mole ratios.

### Temperature

The temperature of the epoxidation reaction will generally depend on the organic acid used. Where the organic acid is acetic acid, the preferred reaction temperature is about 70° C., with a useful range between about 50° C. to 80° C. with a more preferred range of 65° C. to about 75° C., and most preferred reaction temperature range of from 65° C. to about 70° C.

In one embodiment of the process of the invention, the peroxide, carboxylic acid and acid catalyst are added to the polyisobutylene and solvent while maintaining the reaction temperature below about a 15° C., preferably a 10° C., increase from ambient temperature, i.e., 18° C. to 20° C. This was found to be preferred for preventing or minimizing side-reactions. After the addition of the peroxide, carboxylic acid and acid catalyst, the reaction temperature is raised to about 50° C. to 80° C., preferably about 60° C. to 75° C., and most preferably about 65° C. to 70° C. to form the polyisobutylene epoxide.

### Pressure

The epoxidation reaction is typically conducted under atmospheric pressure and under an inert atmosphere of nitrogen. The preferred reaction pressures are in the range of from 1 psi (6.895 kPa) to about 50 psi (344.75 kPa), preferably in the range of from 2 psi (13.79 kPa) to about 40 psi (275.8 kPa), more preferably in the range of from 5 psi (200 kPa) to about 30 psi (206.85 kPa), and most preferably in the range of from 5 psi (200 kPa) to 25 psi (172.37).

Process of the Invention

### Epoxidation Step

Generally, the epoxidation reaction occurs by reacting of an unsaturated olefin, preferably a polyisobutylene (PIB), dissolved in a non-reactive solvent or diluent, preferably a hydrocarbon, with a peroxide, preferably hydrogen peroxide, in the presence of a carboxylic acid, preferably an organic carboxylic acid, and an acid catalyst, preferably a mineral acid catalyst. It is preferable to add the PIB and the solvent or diluent to the reactor to the reactor first forming a first mixture (preferably to complete dissolution), and then following by adding a second mixture of hydrogen peroxide, carboxylic acid and acid catalyst to the reactor containing the first mixture. It also preferable to control the addition, and the exotherm, to prevent side-reactions, such that the overall reaction temperature in the reactor vessel remains within 10° C. of ambient temperature, preferably between about 18° C. to 22° C. depending on outside influences affecting the air temperature.

The reaction between the PIB, peroxide, carboxylic acid, and acid catalyst includes two phases, a non-aqueous phase, i.e., the organic phase, and an aqueous phase, i.e., the water phase. The non-aqueous phase comprises primarily the as-synthesized, PIB epoxide, and the aqueous phase comprises primarily water, organic acid and acid catalyst. The first and second mixture, the reactants, are preferably agitated sufficiently and for a sufficient amount of time, to allow intimate contact between the aqueous and nonaqueous phases. The rate of agitation is dependent on the specific reactor design. In the most preferred embodiment, the reactor vessel is preferably a single reactor vessel that includes an agitator.

### Separation Step

The following step in the process of the invention includes a separation step for separating the non-aqueous phase from the aqueous phase. This is accomplished by methods well known in the art employing various techniques and/or processes such as decanting or removing the water phase, which is typically a bottom layer of the reaction mixture. This can be accomplished in the reaction system through a bottom valve or nozzle. The isolated, non-aqueous phase is then washed (as discussed further herein). In each subsequent washing and neutralization step, the top layer is typically the non-aqueous phase and will contain the desired product and the bottom water or aqueous phase will be separated and discarded.

Separation in a preferred embodiment is further accomplished by cooling the reactor contents, the reaction mixture, to a reactor temperature of from about 45° C. to about 50° C., preferably 50° C.

### Washing and Neutralization Step

Once separated, the non-aqueous phase is subject to multiple washing steps and neutralization steps for the purpose of providing for a high olefin conversion and a high epoxide yield in the final product, i.e., the PIB epoxide, and elimination of residual acids.

In one embodiment of the process above, the washing step and neutralization step are performed sequentially, simultaneously, or alternatively. In a preferred embodiment, the washing step is performed first, one, two or three times prior to the neutralization step. In another embodiment, the neutralization step is performed one, two or three times after the washing step, preferably twice, and optionally followed by one or more washing step(s). Optionally, additional washing steps may be added after the neutralization step.

In a preferred embodiment of the process of the invention, the as-synthesized polyisobutylene epoxide in the non-aqueous phase is subjected to one or more washing step(s) following by one or more neutralization step(s) utilizing one or more washing agent(s) and neutralization agent(s). Washing agents are selected from water, most preferably de-ionized water. Neutralization agents are selected from a family of weak bases such as sodium carbonate, sodium bicarbonate, and the like most preferably sodium bicarbonate. The number of washing and neutralization steps are sufficient to obtain a level of free acid in the final PIB epoxide product, to enable the product to have a relatively neutral.

To ensure that substantially all the acid is removed from the non-aqueous phase, neutralization steps are performed. A dilute weak base solution to wash the non-aqueous phase, i.e., the organic phase is employed.

In some cases, depending on the Mn, a stabilized emulsion layer (also referred to as a third layer) develops between the aqueous phase, and the non-aqueous phase. This third layer is often called a rag layer and is undesirable because it lengthens the wash/neutralization period in removing it from the reaction mixture, and potentially reduces the recoverable yield due to desired polyisobutylene epoxide product being bound to the rag layer. It is therefore preferred in order to obtain a high purity PIB epoxide in high yield, especially when a higher Mn PIB is used, to avoid producing this rag layer. A rag layer was not observed when the process of the invention used a lower Mn PIB for making the PIB epoxide. The rag layer was observed to form when using higher Mn PIB's (>1500 Mn) during the neutralization step. Thus, it is preferred when the process of the invention for making a PIB epoxide uses a high Mn PIB, that as much acid as possible is removed from the first washing steps in order to minimize or prevent rag layer formation during neutralization.

The organic, non-aqueous phase comprising the PIB epoxide is separated from the aqueous phase, and the non-aqueous phase is then washed and neutralized one or more times with water, an aqueous weak base solution and thereafter with water, preferably deionized water again, to reduce and/or eliminate any free acid from the PIB epoxide. The free acid present is the result of the starting reagents. Free acid may result in shortening the storage stability of the resulting PIB epoxide final product rearrangement to unwanted side products. The rearrangement occurs by reacting with the epoxide moiety, and thereby lowering of the amount of PIB epoxide in the final product.

The cause for the rag layer is believed to be likely from residual sodium acetate formed as a byproduct when neutralizing acetic acid with the neutralizing agent, sodium bicarbonate. Sodium acetate is known to be an effective emulsion stabilizer. While not wanting to be bound by theory it is believed that emulsion stabilizers typically function by reducing the interfacial tension between the non-aqueous and aqueous phases. Lower interfacial tension between phases allows the formation of the rag layer which is comprised of PIB epoxide, sodium acetate and water. The presence of the rag layer results in lowering the overall process efficiency of the reaction, in particular the delay in waiting for the dissipation of the emulsion that forms between washing steps.

To minimize the formation of the rag layer, it is preferred to remove all or substantially all the acid, preferably acetic acid, in the first washing step(s). The number of initial washing steps in the process of the invention is from 1 to 4, preferably 2 to 3, using de-ionized water. The number of neutralization steps depends ultimately on the pH of the final product, and in one embodiment the number of neutralization steps is from 1 to about 3, preferably about 1 to 2, using sodium bicarbonate. In another embodiment, the initial washing steps with de-ionized water are performed followed by neutralization steps, and then followed by final washing steps.

In one embodiment, it is preferable that after washing and neutralization, the PIB epoxide remaining has a pH of from about 6 to about 8, preferably about 6.5 to 7.5, and most preferably about 7.

Therefore, in some examples below additional washing steps were added before the neutralization step and one of the bicarbonate washes was eliminated. In these examples, the rag layer persisted, however appeared less emulsified and resulted in a higher desired PIB epoxide recovery.

It is well understood that there are various techniques for drying a non-aqueous solution such as using a drying agent, using a lower pressure such as a vacuum, heating the non-aqueous solution under vacuum and the like.

In one embodiment of the process of the invention, the process of making an olefin epoxide, preferably a polyisobutylene epoxide, comprising the steps of (a) contacting in a reactor vessel, preferably a single reactor vessel, polyisobutylene with a (i) a diluent or solvent, preferably a solvent capable of solubilizing the polyisobutylene, (ii) a peroxide, preferably hydrogen peroxide, (iii) a carboxylic acid, and (iv) an acid catalyst, preferably a mineral acid catalyst, forming a reaction mixture of a non-aqueous phase and an aqueous phase (b) reacting the mixture for a time sufficient to form the polyisobutylene epoxide; (c) separating the non-aqueous phase from the aqueous phase; (d) washing the non-aqueous phase with preferably water to remove substantially all the unreacted and remaining carboxylic acid and acid catalyst and (e) neutralizing the non-aqueous phase with a neutralizing agent, in particularly sodium bicarbonate for reducing the pH, and (e) isolating and drying the polyisobutylene epoxide.

In a preferred embodiment the polyisobutylene epoxide of the invention isolated and dried in step (e) indicates equal to or greater than about 90% olefin conversion and equal to or greater than about 90% epoxide yield as measured by ¹H-NMR. In yet another embodiment, the polyisobutylene epoxide of the invention isolated and dried in step (e) indicates at least 93% olefin conversion and at least a 93%, epoxide yield as measured by ¹H-NMR.

### Uses for the PIB Epoxide of the Invention

There are many uses for the PIB epoxide made by the process of the invention. In one such example, the PIB epoxide is converted into a polyisobutylene alcohol amine (PIBAA). This process for making PIBAA involves reacting a PIB epoxide made by the process of the invention with an amine compound to form a PIBAA compound.

In particular PIBAA compositions are useful as a dispersant additive in a motor oil lubricant formulation and as a fuel additive formulation. It may also be useful to improve the strength and durability of products such as adhesives, sealants, oils, greases.

Furthermore, PIBAA may also be used in formulation for dispersants, lubricants, greases, corrosion inhibitors, gear oils, and base stocks or even in explosive emulsion formulations.

Epoxidized PIB is useful as an additive in adhesives, coatings, and urethanes. It may also be used in cutting oils, lubricants and viscosity modifiers. Uses can also be found in plastics, especially polyvinyl chloride and its copolymers, to keep them soft and pliable.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Testing Analysis and Protocol

The oxirane value of the polyisobutylene epoxides (PIB epoxides) was determined using Test Process AOCS Cd9-57. Quantitative determination of the PIB epoxides was based on ¹H NMR.

Products were characterized by ¹H NMR as follows: NMR spectra were recorded on a Bruker 600 MHz Neo Digital NMR Spectrometer at ambient temperature. All chemical shifts were referenced to tetramethylsilane (TMS) as external standard and referenced to the residual proton and carbon signals of CDCl₃ solvent at δH 7.24 ppm. Samples were prepared with 60-100 mg in 0.5 mL of CDCl₃ (obtained from Sigma Aldrich). Spectra were analyzed by Fourier transform, with phase and baseline corrected by Bruker Top Spin (version 4.0.7) automated routines. Manual integration and selected peak normalization of the integrals by desired peak was applied to all spectra. The integration regions were spread over a range of at least 25 times of the line width (Hz) of the peak in both directions, and the data derived from the peak integration was taken as an average of three separate manual measurements to minimize experimental uncertainty.

GPC was determined as follows: GPC calibrated to the polyisobutylene standard. Molecular weights, (Mn, Mw, Mz) (were measured with a Viscotek GPC max VE 2001 instrument equipped with a Viscotek 302 detector refractometer, and three Ultrastyragel GPC columns connected in the following series: 10⁴, 500, and 100 Å. THF was used as a carrier solvent with a flow rate of 1 mL/min. Polymer Standards-Narrow MWD (Mw/Mn<1.1) polyisobutylene standards of known molecular weight (available from several suppliers) are used for calibration. The polymer samples were dissolved in the THF from the GPC reservoir to prepare 5 mg/mL polymer solutions. The polymer solutions were filtered through 0.22 μm PTFE filters before injection.

### Chemicals/Materials Used

The following materials were used in the examples disclosed herein. The polyisobutylene used were commercial grades produced by TPC Group, Houston, Texas under the tradenames: HRPIB 545, HRPIB 595 and HRPIB 5230. The following chemicals were purchased by Sigma Aldrich and used as received: hexanes (typically 95% +), hydrogen peroxide (H₂O₂), 50 wt %, sulfuric acid (H₂SO₄), 93+%, acetic acid glacial (HOAc or CH₃COOH), 99+wt %; sodium bicarbonate (NaHCO₃) and sodium sulfate (Na₂SO₄); and water (H₂O) was distilled and demineralized using techniques known in the art.

### Experiments

### Example 1

A 2.0 L flask equipped with a mechanical stirrer, a reflux condenser, an addition funnel, and a heating mantle was charged with 101.9 g of TPC 545 PIB (TPC Group; Mn˜450) and 92.5 g of hexanes. The mixture was stirred at ambient temperature until the PIB solution was complete. An addition funnel was then charged with 13.4 g of glacial acetic acid, 2.4 g of 95.7% sulfuric acid and 38.2 g of 50% hydrogen peroxide and homogenized. The contents of the addition funnel were added dropwise into the PIB solution over a period of one hour so that the temperature of the solution was kept below a 10° C. increase over the starting ambient temperature. After the addition was complete, the mixture was then heated to 60° C. while stirring for 2 additional hours. The reaction was then cooled to approximately 50° C. and the aqueous phase was separated and discarded. The organic phase was washed twice with 300 mL of deionized water to remove the acids from the PIB epoxide, as synthesized, product. The organic phase containing the desired PIB epoxide was additionally washed twice with a 300 ml of a dilute sodium bicarbonate solution to neutralize any remaining acid, and the formed aqueous phase was discarded. The remaining PIB epoxide solution was then washed twice with 300 mL of deionized water. The epoxidized PIB was then dried and stripped of solvent and contained 87% epoxide yield as analyzed by ¹H NMR.

### Example 2

Example 2 followed the procedure of Example 1 except it used 215.6 g of TPC 545 PIB, 171.1 g hexanes, 26.8 g of glacial acetic acid, 5.0 g of 95.7% sulfuric acid and 77.2 g of 50% hydrogen peroxide and the mixture was then heated to 70° C. while stirring for 2 additional hours. After washing, the epoxidized PIB was dried and stripped of solvent and contained 95% epoxide yield as analyzed by ¹H NMR.

### Example 3

Example 3 followed the procedure of Example 2 except it used 401.5 g of TPC 545 PIB, 404.2 g hexanes, 54.4 g of glacial acetic acid, 10.2 g of 95.7% sulfuric acid and 151.2 g of 50% hydrogen peroxide. After washing, the epoxidized PIB was dried and stripped of solvent and contained 95% epoxide yield as analyzed by ¹H NMR.

### Example 4

Example 4 followed the procedure of Example 2 except it used 399.9 g of TPC 545 PIB, 400.7 g hexanes, 53.3 g of glacial acetic acid, 10.7 g of 95.7% sulfuric acid and 217.4 g of 30% hydrogen peroxide. After washing, the epoxidized PIB was dried and stripped of solvent and contained 83% epoxide yield as analyzed by ¹H NMR.

### Example 5

Example 5 followed the procedure of Example 2 except it used 199.4 g of TPC 545 PIB, 202.6 g hexanes, 26.9 g of glacial acetic acid, 5.1 g of 95.7% sulfuric acid and 76.4 g of 50% hydrogen peroxide. After washing, the epoxidized PIB was dried and stripped of solvent and contained 92% epoxide yield as analyzed by ¹H NMR.

### Example 6

Example 6 followed the procedure of Example 2 except it used 249.9 g of TPC 545 PIB, 250.3 g hexanes, 36.8 g of glacial acetic acid, 6.4 g of 95.7% sulfuric acid and 94.4 g of 50% hydrogen peroxide. After washing, the epoxidized PIB was dried and stripped of solvent and contained 95% epoxide yield as analyzed by ¹H NMR.

### Example 7

Example 7 followed the procedure of Example 2 except it used 199.9 g of TPC 545 PIB, 199.2 g hexanes, 26.6 g of glacial acetic acid, 5.0 g of 95.7% sulfuric acid and 75.8 g of 50% hydrogen peroxide. After washing, the epoxidized PIB was dried and stripped of solvent and contained 94% epoxide yield as analyzed by ¹H NMR.

### Example 8

Example 8 followed the procedure of Example 2 except it used 193.4 g of TPC 545 PIB, 195.2 g hexanes, 26.7 g of glacial acetic acid, 5.0 g of 95.7% sulfuric acid and 76.6 g of 50% hydrogen peroxide. After washing, the epoxidized PIB was dried and stripped of solvent and contained 95% epoxide yield as analyzed by ¹H NMR.

### Example 9

Example 9 followed the procedure of Example 2 except it used 199.3 g of TPC 545 PIB, 198.5 g hexanes, 26.9 g of glacial acetic acid, 4.9 g of 95.7% sulfuric acid and 75.5 g of 50% hydrogen peroxide. After washing, the epoxidized PIB was dried and stripped of solvent and contained 94% epoxide yield as analyzed by ¹H NMR.

### Example 10

Example 10 followed the procedure of Example 2 except it used 198.8 g of TPC 545 PIB, 198.4 g hexanes, 26.6 g of glacial acetic acid, 5.1 g of 95.7% sulfuric acid and 75.6 g of 50% hydrogen peroxide. After washing, the epoxidized PIB was dried and stripped of solvent and contained 95% epoxide yield as analyzed by ¹H NMR.

### Example 11

Example 11 followed the procedure of Example 2 except it used 199.5 g of TPC 545 PIB, 199.2 g hexanes, 26.6 g of glacial acetic acid, 5.1 g of 95.7% sulfuric acid and 76.51 g of 50% hydrogen peroxide. After washing, the epoxidized PIB was dried and stripped of solvent and contained 94% epoxide yield as analyzed by ¹H NMR.

### Example 12

Example 12 followed the procedure of Example 2 except it used 391.4 g of TPC 595 PIB (Mn˜1000), 402.5 g hexanes, 27.3 g of glacial acetic acid, 9.2 g of 95.7% sulfuric acid and 71.7 g of 50% hydrogen peroxide. After washing, the epoxidized PIB was dried and stripped of solvent and contained 96% epoxide yield as analyzed by ¹H NMR.

### Example 13

Example 13 followed the procedure of Example 2 except it used 403.3 g of TPC 595 PIB (Mn˜1000), 405.5 g hexanes, 25.5 g of glacial acetic acid, 9.8 g of 95.7% sulfuric acid and 71.6 of 50% hydrogen peroxide. After washing, the epoxidized PIB was dried and stripped of solvent and contained 93% epoxide yield as analyzed by ¹H NMR.

### Example 14

Example 14 followed the procedure of Example 2 except it used 401.3 g of TPC 595 PIB (Mn˜1000), 398.8 g hexanes, 25.5 g of glacial acetic acid, 4.5 g of 95.7% sulfuric acid and 72.9 of 50% hydrogen peroxide. After washing, the epoxidized PIB was dried and stripped of solvent and contained 93% epoxide yield as analyzed by ¹H NMR.

### Example 15

Example 15 followed the procedure of Example 2 except it used 199.2 g of TPC 595 PIB (Mn˜1000), 204.8 g hexanes, 12.7 g of glacial acetic acid, 2.3 g of 95.7% sulfuric acid and 36.7 of 50% hydrogen peroxide. After washing, the epoxidized PIB was dried and stripped of solvent and contained 90% epoxide yield as analyzed by ¹H NMR.

### Example 16

Example 16 followed the procedure of Example 2 except it used 199.3 g of TPC 595 PIB (Mn˜1000), 203.9 g hexanes, 12.7 g of glacial acetic acid, 2.2 g of 95.7% sulfuric acid and 36.5 of 50% hydrogen peroxide. After washing, the epoxidized PIB was dried and stripped of solvent and contained 92% epoxide yield as analyzed by ¹H NMR.

### Example 17

Example 17 followed the procedure of Example 2 except it used 199.2 g of TPC 595 PIB (Mn˜1000), 204.2 g hexanes, 12.8 g of glacial acetic acid, 2.3 g of 95.7% sulfuric acid and 36.2 of 50% hydrogen peroxide. After washing, the epoxidized PIB was dried and stripped of solvent and contained 90% epoxide yield as analyzed by ¹H NMR.

### Example 18

Example 18 followed the procedure of Example 2 except it used 198.7g of TPC 595 PIB (Mn˜1000), 199.4 g hexanes, 12.6 g of glacial acetic acid, 2.4 g of 95.7% sulfuric acid and 36.5 of 50% hydrogen peroxide. After washing, the epoxidized PIB was dried and stripped of solvent and contained 91% epoxide yield as analyzed by ¹H NMR.

### Example 19

Example 19 followed the procedure of Example 2 except it used 199.3 g of TPC 595 PIB (Mn˜1000), 200.2 g hexanes, 13.0 g of glacial acetic acid, 2.3 g of 95.7% sulfuric acid and 36.5 of 50% hydrogen peroxide. After washing, the epoxidized PIB was dried and stripped of solvent containing 91% epoxide yield as analyzed by ¹H NMR.

### Example 20

Example 20 followed the procedure of Example 2 except it used 197.0 g of TPC 595 PIB (Mn˜1000), 200.5 g hexanes, 12.8 g of glacial acetic acid, 2.4 g of 95.7% sulfuric acid and 36.8 of 50% hydrogen peroxide. After washing, the epoxidized PIB was dried and stripped of solvent and contained 92% epoxide yield as analyzed by ¹H NMR.

### Example 21

Example 21 followed the procedure of Example 2 except it used 401.5 g of TPC 5230 PIB (Mn˜2300), 403.5 g hexanes, 10.5 g of glacial acetic acid, 8.7 g of 95.7% sulfuric acid and 30.0 of 50% hydrogen peroxide. After washing, the epoxidized PIB was dried and stripped of solvent and contained 95% epoxide yield as analyzed by ¹H NMR.

### Example 22

Example 22 followed the procedure of Example 2 except it used 399.8 g of TPC 5230 PIB (Mn˜2300), 400.0 g hexanes, 10.4 g of glacial acetic acid, 8.4 g of 95.7% sulfuric acid and 29.6 of 50% hydrogen peroxide. After washing, the epoxidized PIB was dried and stripped of solvent and contained 95% epoxide yield as analyzed by ¹H NMR.

### Example 23

Example 23 followed the procedure of Example 2 except it used 397.4 g of TPC 5230 PIB (Mn˜2300), 400.6 g hexanes, 10.4 g of glacial acetic acid, 3.2 g of 95.7% sulfuric acid and 60.7 of 50% hydrogen peroxide. After washing, the epoxidized PIB was dried and stripped of solvent and contained 81% epoxide yield as analyzed by ¹H NMR.

### Example 24

Example 24 followed the procedure of Example 2 except it used 397.3 g of TPC 5230 PIB (Mn˜2300), 398.7 g hexanes, 10.9 g of glacial acetic acid, 3.3 g of 95.7% sulfuric acid and 59.6 of 50% hydrogen peroxide. After washing, the epoxidized PIB was dried and stripped of solvent and contained 84% epoxide yield as analyzed by ¹H NMR.

### Example 25

Example 25 followed the procedure of Example 2 except it used 398.7 g of TPC 5230 PIB (Mn˜2300), 400.2 g hexanes, 20.90 g of glacial acetic acid, 3.8 g of 95.7% sulfuric acid and 59.9 of 50% hydrogen peroxide. After washing, the epoxidized PIB was dried and stripped of solvent and contained 87% epoxide yield as analyzed by ¹H NMR.

### Example 26

Example 26 followed the procedure of Example 2 except it used 505.6 g of TPC 5230 PIB (Mn˜2300), 515.4 g hexanes, 26.1 g of glacial acetic acid, 4.7 g of 95.7% sulfuric acid and 74.0 of 50% hydrogen peroxide. After washing, the epoxidized PIB was dried and stripped of solvent and contained 98% epoxide yield by ¹H NMR.

### Example 27

Example 27 followed the procedure of Example 2 except it used 498.0 g of TPC 5230 PIB (Mn˜2300), 499.0 g hexanes, 26.2 g of glacial acetic acid, 4.8 g of 95.7% sulfuric acid and 74.0 of 50% hydrogen peroxide. After washing, the epoxidized PIB was dried and stripped of solvent and contained 98% epoxide yield as analyzed by ¹H NMR.

### Example 28

Example 28 followed the procedure of Example 2 except it used 1849 g of TPC 545 PIB, 1804 g hexanes, 113.8 g of glacial acetic acid, 16.1 g of 95.7% sulfuric acid and 322.0 g of 50% hydrogen peroxide. After washing, the epoxidized PIB was dried and stripped of solvent and contained 87% epoxide yield as analyzed by ¹H NMR.

### Example 29

Example 29 followed the procedure of Example 2 except it used 1799 g of TPC 595 PIB (Mn˜1000), 1850 g hexanes, 113.8 g of glacial acetic acid, 16.1 g of 95.7% sulfuric acid and 322 of 50% hydrogen peroxide. After washing, the epoxidized PIB was dried and stripped of solvent and contained 85% epoxide yield as analyzed by ¹H NMR.

### Example 30

Example 30 followed the procedure of Example 2 except it used 1798 g of TPC 595 PIB (Mn˜1000), 1850 g hexanes, 113.8 g of glacial acetic acid, 16.1 g of 95.7% sulfuric acid and 322 of 50% hydrogen peroxide. After washing, the epoxidized PIB was dried and stripped of solvent and contained 89% epoxide yield as analyzed by ¹H NMR.

### Example 31

Example 31 followed the procedure of Example 2 except it used 1825 g of TPC 5230 PIB (Mn˜2300), 1900 g hexanes, 94 g of glacial acetic acid, 13.3 g of 95.7% sulfuric acid and 266 of 50% hydrogen peroxide. After washing, the epoxidized PIB was dried and stripped of solvent and contained 98% epoxide yield as analyzed by ¹H NMR.

### Example 32

Example 32 followed the procedure of Example 2 except it used 1868 g of TPC 5230 PIB (Mn˜2300), 1840 g hexanes, 94 g of glacial acetic acid, 13.3 g of 95.7% sulfuric acid and 266 of 50% hydrogen peroxide. After washing, the epoxidized PIB was dried and stripped of solvent and contained 94% epoxide yield by ¹H NMR.

### Example 33

Example 33 followed the procedure of Example 2 except it used 1847 g of TPC 5230 PIB (Mn˜2300), 1743 g hexanes, 94 g of glacial acetic acid, 13.3 g of 95.7% sulfuric acid and 266 of 50% hydrogen peroxide. After washing, the epoxidized PIB was dried and stripped of solvent and contained 99% epoxide yield as analyzed by ¹H NMR.

### Example 34

Example 34 followed the procedure of Example 2 except it used 1816 g of TPC 5230 PIB (Mn˜2300), 1875 g hexanes, 94 g of glacial acetic acid, 13.3 g of 95.7% sulfuric acid and 266 of 50% hydrogen peroxide. After washing, the epoxidized PIB was dried and stripped of solvent and contained 95% epoxide yield as analyzed y ¹H NMR.

### Example 35

Example 35 followed the procedure of Example 2 except it used 1831 g of Soltex PB32 (conventional PIB) (Mn˜1500), 1856 g hexanes, 113.8 g of glacial acetic acid, 16.1 g of 95.7% sulfuric acid and 322 of 50% hydrogen peroxide. After washing, the epoxidized PIB was dried and stripped of solvent and contained 67% epoxide yield as analyzed by ¹H NMR.

### Tables

The following tables illustrate various runs for obtaining a PIB epoxide of high purity and high yield. All runs were performed in a one-pot, reactor or reaction vessel, in primarily a one-step reaction, followed by a washing, isolating and drying step of the final product, the PIB epoxide, as discussed above under Experiments.

TABLE 1

| Example Number | 1 | 2 | 3 | 4 |
|---|---|---|---|---|
| PIB Type | TPC | TPC | TPC | TPC |
| | 545 | 545 | 545 | 545 |
| PIB Mn | 450 | 450 | 450 | 450 |
| % H₂SO₄ | 4.25 | 4.39 | 4.52 | 3.64 |
| Peroxide/olefin mole ratio | 2.48 | 2.37 | 2.49 | 3.60 |
| Acetic Acid/olefin mole ratio | 0.99 | 0.93 | 1.02 | 1.00 |
| Oxirane wt % O | 1.68 | 1.70 | 1.80 | 1.52 |
| Epoxide Yield (¹H-NMR) | 87% | 95% | 95% | 83% |
| Olefin Conversion (¹H-NMR) | 88% | 95% | 95% | 83% |

Table 1 above provides the reaction conditions and the polyisobutylene epoxidation results using a low number average molecular weight polyisobutylene, in this case a polyisobutylene with a Mn of approximately 450. Proton Nuclear Magnetic Resonance (¹H-NMR) was used to determine olefin (conversion of the double bond present in polyisobutylene), and the epoxide yield (mole percent epoxide). Table 1 illustrates the high olefin conversion and epoxide yield are achieved using the process conditions where one or more, preferably all of the following ratios are satisfied: (a) the percent catalyst acid (sulfuric acid) is greater than about 4% as defined above, (b) the peroxide (hydrogen peroxide)/olefin mole ratio of about 2.5 to about 3.5, and (c) the carboxylic acid (acetic acid)/olefin mole ratio is about 1.

When 35% hydrogen peroxide was used as a reagent, surprisingly the percentage epoxide decreased, hence it was found that greater than 35% hydrogen peroxide is not preferred. The optimized reaction conditions produced a PIB epoxide having a yield and conversion of 95%.

Increasing the temperature from 60° C. to 70° C. after the addition of the aqueous phase (peroxide/organic acid/mineral acid) to the nonaqueous phase (PIB/diluent) as comparing Example 1 to Example 2, increased the olefin conversion from 88% to 95% and the epoxide yield from 87% to 95%.

TABLE 2

| | Example Number | | | | | | |
|---|---|---|---|---|---|---|---|
| | 5 | 6 | 7 | 8 | 9 | 10 | 11 |
| PIB Type | TPC545 | TPC545 | TPC545 | TPC545 | TPC545 | TPC545 | TPC545 |
| PIB Mn | 450 | 450 | 450 | 450 | 450 | 450 | 450 |
| % H₂SO₄ | 4.50 | 4.45 | 4.46 | 4.41 | 4.37 | 4.55 | 4.52 |
| Peroxide/olefin | 2.54 | 2.50 | 2.51 | 2.62 | 2.51 | 2.52 | 2.52 |
| mole ratio | | | | | | | |
| Acetic | 1.01 | 1.10 | 1.00 | 1.04 | 1.01 | 1.00 | 1.00 |
| Acid/olefin | | | | | | | |
| mole ratio | | | | | | | |
| Epoxide Yield | 92% | 95% | 94% | 95% | 94% | 95% | 94% |
| (¹H-NMR) | | | | | | | |
| Olefin | 93% | 95% | 95% | 95% | 95% | 95% | 94% |
| Conversion | | | | | | | |
| (¹H-NMR) | | | | | | | |

Table 2 above illustrates additional runs of the process of the invention using a low molecular weight PIB (PIB 545) to form the polyisobutylene epoxide. ¹HNMR olefin conversion again shows greater than 90%, and primarily greater than 93% conversion to the desired purity epoxide with yield up to 95%.

TABLE 3

| Example Number | 12 | 13 | 14 |
|---|---|---|---|
| PIB Type | TPC595 | TPC595 | TPC595 |
| PIB Mn | 950 | 950 | 950 |
| % H₂SO₄ | 8.14 | 8.77 | 4.19 |
| Peroxide/olefin mole ratio | 2.92 | 2.91 | 2.83 |
| Acetic Acid/olefin mole ratio | 1.26 | 1.17 | 1.12 |
| Epoxide Yield (¹H-NMR) | 96% | 93% | 93% |
| Olefin Conversion (¹H-NMR) | 96% | 93% | 94% |

Table 3 above illustrates the process of the invention for making a polyisobutylene epoxide from using TPC595 (Mn of about 1000) as the olefin and the results show a greater than 90% olefin conversion to a high yield PIB epoxide with yields greater than 93% as analyzed by ¹H-NMR. The optimized preparation, mole ratios, for low and medium number average molecular weight PIB with a Mn of from about 400 to about 1200 was found to be one or more of, preferably all of, (a) about 4 wt % to 8 wt % catalyst acid (sulfuric acid), (b) the peroxide (hydrogen peroxide)/olefin mole ratio of about 2.5 to about 3.5, and (c) the carboxylic acid (acetic acid)/olefin mole ratio of from about 1 to 1.5.

TABLE 4

| | Example Number | | | | | |
|---|---|---|---|---|---|---|
| | 15 | 16 | 17 | 18 | 19 | 20 |
| PIB Type | TPC595 | TPC595 | TPC595 | TPC595 | TPC595 | TPC595 |
| PIB Mn | 950 | 950 | 950 | 950 | 950 | 950 |
| % H₂SO₄ | 4.26 | 4.10 | 4.29 | 4.46 | 4.25 | 4.42 |
| Peroxide/olefin | 2.57 | 2.56 | 2.54 | 2.57 | 2.56 | 2.61 |
| mole ratio | | | | | | |
| Acetic | 1.01 | 1.01 | 1.02 | 1.00 | 1.03 | 1.03 |
| Acid/olefin | | | | | | |
| mole ratio | | | | | | |
| Epoxide Yield | 90% | 92% | 90% | 91% | 91% | 92% |
| (¹H-NMR) | | | | | | |
| Olefin | 90% | 92% | 90% | 91% | 92% | 92% |
| Conversion | | | | | | |
| (¹H-NMR) | | | | | | |

Table 4 above shows by using the process conditions where one or more, preferably all of the following ratios described above results in consistently producing polyisobutylene epoxide with olefin selectivity and epoxide yield both greater than 90% as measured by ¹H-NMR for a PIB having a Mn of about 1000.

TABLE 5

| | Example Number | | | | | | |
|---|---|---|---|---|---|---|---|
| | 21 | 22 | 23 | 24 | 25 | 26 | 27 |
| PIB Type | TPC5230 | TPC5230 | TPC5230 | TPC5230 | TPC5230 | TPC5230 | TPC5230 |
| PIB Mn | 2300 | 2300 | 2300 | 2300 | 2300 | 2300 | 2300 |
| % H₂SO₄ | 16.9 | 16.6 | 4.1 | 4.3 | 4.3 | 4.3 | 4.37 |
| Peroxide/olefin | 2.5 | 2.5 | 5.2 | 5.1 | 5.1 | 5.0 | 5.03 |
| mole ratio | | | | | | | |
| Acetic | 1.0 | 1.0 | 1.0 | 1.1 | 2.0 | 2.0 | 2.02 |
| Acid/olefin | | | | | | | |
| mole ratio | | | | | | | |
| Epoxide Yield | 95% | 95% | 81% | 84% | 87% | 98% | 98% |
| (¹H-NMR) | | | | | | | |
| Olefin | 96% | 96% | 81% | 88% | 94% | 98% | 98% |
| Conversion | | | | | | | |
| (¹H-NMR) | | | | | | | |

Table 5 above illustrates the process of the invention utilizing a higher number average molecular weight polyisobutylene with a Mn of about 2300 as the olefin. Examples 26 and 27 of the invention illustrate an improvement compared to Examples 23 and 24 where the acetic acid/olefin mole ratio was increased from about 1 to about 2 while utilizing a higher peroxide/olefin mole ratio (at about 5) while maintaining a consistent weight percent acid catalyst in the aqueous phase. This results in a greater olefin conversion and epoxide yield both at 98% as measured by ¹H-NMR.

While not wishing to be bound by any particular theory, it is believed that the higher molecular weight polyisobutylene, has a lower concentration of double bonds by weight and a much higher viscosity, which presents a larger challenge for the oxidant, peroxide/acetic acid/mineral acid mixture, to reach the double bond in the polyisobutylene. In theory, a stronger peroxidizing aqueous phase is achieved by increasing the mole ratio of both the carboxylic acid/olefin and peroxide/olefin that increases the likelihood of epoxidation of the double bond contained in the higher Mn polyisobutylene. Examples 21 and 22 show that a stronger peroxidizing aqueous phase was successfully employed by increasing the weight percent of the acid catalyst.

The optimized preparation, mole ratios, for high number average molecular weight polyisobutylene with a Mn of from about 2000 to about 2500 was found to be one or more of, preferably all of, (a) about 4 wt % to 6 wt % catalyst acid (sulfuric acid), (b) the peroxide (hydrogen peroxide)/olefin mole ratio of about 5 to about 6, and (c) the carboxylic acid (acetic acid)/olefin mole ratio of from about 2 to about 2.5.

TABLE 6

| | Example No. | | | | | | | |
|---|---|---|---|---|---|---|---|---|
| | 28 | 29 | 30 | 31 | 32 | 33 | 34 | 35 |
| PIB | TPC545 | TPC595 | TPC595 | TPC5230 | TPC5230 | TPC5230 | TPC5230 | PB32 |
| GPC Mn | 450 | 950 | 950 | 2300 | 2300 | 2300 | 2300 | 1500 |
| % H₂SO₄ | 3.56 | 3.56 | 3.56 | 3.56 | 3.56 | 3.56 | 3.56 | 3.56 |
| peroxide/olefin | 1.15 | 2.50 | 2.50 | 4.93 | 4.82 | 4.87 | 4.96 | 3.88 |
| AA to olefin | 0.46 | 1.00 | 1.00 | 1.97 | 1.93 | 1.95 | 1.98 | 1.66 |
| Initial Washing | 3x | 2x | 2x | 2x | 3x | 3x | 3x | 3x |
| | water | water | water | water | water | water | water | water |
| Neutralization | 2X | 2X | 2X | 2X | 1X | 1X | 1X | 2X |
| | bicarb | bicarb | bicarb | bicarb | bicarb | bicarb | bicarb | bicarb |
| Final Washing | 2x | 2x | 2x | 2x | 2x | 2x | 2x | 2x |
| | water | water | water | water | water | water | water | water |
| pH after wash #1 | 1 | 1 | 1 | 1 | 1 | 2 | 1 | 1 |
| pH after wash #2 | 3 | 3 | 3 | 3 | 3 | 3 | 3 | 3 |
| pH after wash #3 | 3 | 10 | 10 | 7 | 4 | 4 | 4 | 4 |
| pH after wash #4 | 10 | 10 | 10 | 7 | 7 | 7 | 10 | 6 |
| pH after wash #5 | 9 | 8 | 8 | 7 | 6 | 6 | 8 | 7 |
| pH after wash #6 | 7 | 5 | 7 | 7 | 5 | 5 | 6 | 7 |
| pH after wash #7 | 5 | | | | | | | 6 |
| Oxirane wt % O | 1.900 | 0.87 | 0.88 | 0.360 | 0.395 | 0.382 | 0.403 | 0.529 |
| Epoxide Yield | 87% | 85% | 89% | 98% | 94% | 95% | 94% | 67% |
| (¹H-NMR) | | | | | | | | |
| Conversion | 87% | 86% | 89% | 99% | 99% | 99% | 99% | 72% |
| (¹H-NMR) | | | | | | | | |

Examples 28 through 34 provided in Table 6 above demonstrate the scale-up of the process of the invention for preparing a polyisobutylene epoxide at an approximate 2 Kg scale. Examples 31 to 35 using a highly reactive polyisobutylene having a Mn of about 2300 show the reaction conditions for the process of the invention result in olefin conversions of about 99% and epoxide yield greater than 94% and up to 98% as measured by ¹HNMR.

The data in Table 6 show preferred reaction conditions for preparing a polyisobutylene epoxide from a low or medium Mn polyisobutylene. The preferred reaction conditions and mole ratios of reactants were one or more of the following, preferably all: (a) about 5 wt % to about 6 wt % percent acid catalyst, sulfuric acid, (b) a peroxide (hydrogen peroxide)/olefin mole ratio of approximately 2.5 to 3.0 and (c) a carboxylic acid (acetic acid)/olefin mole ratio of about 1 to 1.5.

The data in Table 6 also show the preferred reaction conditions for preparing a polyisobutylene epoxide from high number average molecular weight (Mn) polyisobutylene. The preferred reaction conditions and mole ratios of reactants were one or more of the following, preferably all: (a) about 5 wt % to about 6 wt % percent acid catalyst, sulfuric acid; (b) a peroxide (hydrogen peroxide)/olefin mole ratio of approximately 5 to 6; and (c) a carboxylic acid (acetic acid)/olefin mole ratio of about 2 to 2.5.

Example 35 in Table 6 is an exemplification for epoxidizing a medium number average molecular weight polyisobutylene having an Mn of 1500. In this example those conditions did not provide as high olefin conversion of 72% and an epoxide yield of 67%, both measured by ¹H-NMR. While not wanting to be bound by any particular theory, these results suggest that it is more challenging to convert all of the bonds in a conventional polyisobutylene, which contains about 40% of Type 4 or tetrasubstituted double bonds. However, increasing for example the weight percent catalyst to greater than 5wt % or higher, and/or increasing the peroxide to olefin ratio and/or the acetic acid to olefin ratio would improve the olefin conversion and epoxide yield.

The present invention has been described herein with reference to a particular embodiment for a particular application. Although selected embodiments have been illustrated and described in detail, it may be understood that various substitutions and alterations are possible. It is possible that the process could be extended to other chemistries such as epoxidation of other olefins. Those having ordinary skill in the art and access to the present teachings may recognize additional various substitutions and alterations are also possible without departing from the spirit and scope of the present invention, and as defined by the following claims.

What is claimed is:

1. A process for making a polyisobutylene epoxide, the process comprising the steps of (a) reacting in a reactor vessel polyisobutylene olefin with (i) a solvent capable of solubilizing the polyisobutylene, (ii) a peroxide, (iii) a carboxylic acid, and (iv) an acid catalyst, forming a mixture; (b) reacting the mixture for a time sufficient to form a non-aqueous phase comprising a polyisobutylene epoxide and an aqueous phase; (c) separating the non-aqueous phase from the aqueous phase; (d) washing the non-aqueous phase; (e) neutralizing the non-aqueous phase, and, (e) isolating and drying the polyisobutylene epoxide, wherein the mole ratio of peroxide/olefin is from about 1 to about 7, the carboxylic acid/olefin mole ratio is from about 0.5 to about 3, and the weight percent acid catalyst is greater than 1 wt %.

2. The process of claim 1, wherein the mole ratio of peroxide/olefin is from about 1.5 to about 6.

3. The process of claim 1, wherein the mole ratio of the carboxylic acid/olefin is greater than 0.5 to less than 3.

4. The process of claim 1 wherein the weight percent of acid catalyst is greater than 2 wt % to about 20 wt %.

5. The process of claim 1, wherein the polyisobutylene epoxide is selected from the group of Type 1, Type 2, and Type 3 polyisobutylene epoxide.

6. The process of claim 1, wherein the polyisobutylene epoxide is represented by one or more of the formulae: 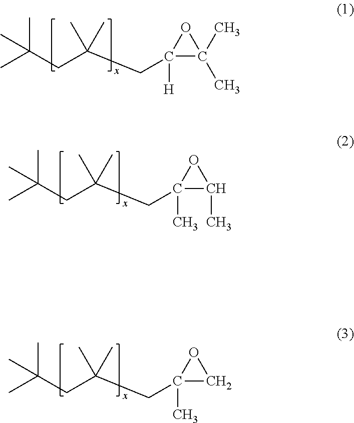
wherein x is an integer from 1 to about 200.

7. The process of claim 1 wherein the polyisobutylene epoxide has a Mn of from about 400 to about 5000 and an oxirane oxygen value of about 3.2% to about 0.20%.

8. The process of claim 1 wherein the polyisobutylene epoxide is an epoxidated highly reactive polyisobutylene having between about 50 mol % to 90 mol % alpha-vinylidene isobutylene isomer content.

9. The process of claim 8 wherein the highly reactive polyisobutylene has a Mn in the range of from about 400 to about 5000.

10. The process of claim 1, wherein the polyisobutylene epoxide isolated and dried in step (e) indicates at least 90% olefin conversion and at least a 90% epoxide yield as measured by ¹H-NMR.

11. A process for making polyisobutylene epoxide, the process comprising the steps of: (a) contacting polyisobutylene olefin and a solvent forming a first mixture in a reactor vessel; (b) forming a second mixture comprising a peroxide, a carboxylic acid, and an acid catalyst; (c) introducing the second mixture to the first mixture in the reactor vessel; (d) reacting the first and second mixtures for a sufficient amount of time at a reactor temperature for forming a non-aqueous phase comprising the polyisobutylene epoxide and an aqueous phase; (e) separating the non-aqueous phase from the aqueous phase; (f) washing the separated non-aqueous phase to form a washed and separated non-aqueous phase; (g) neutralizing the washed and separated non-aqueous phase forming a neutralized, washed and separated non-aqueous phase; and (h) recovering from the neutralized, washed and separated non-aqueous phase a purified polyisobutylene epoxide.

12. The process of claim 11, wherein in the introducing step (c) of the second mixture to the first mixture, the temperature in the reactor vessel is maintained at no more than 15° C. above an ambient reactor temperature.

13. The process of claim 11, wherein the washing step (f) and neutralization step (g) are repeated as many times as necessary to attain a pH of the purified polyisobutylene epoxide of about 6.5 to about 7.5.

14. The process of claim 11, wherein the reactor temperature in step (d) is increased to within the range of from about 60° C. to 80° C.

15. The process of claim 11, wherein the polyisobutylene has a Mn of from about 400 to about 1200, the peroxide/olefin mole ratio is from about 2.5 to about 3.5, the carboxylic acid/olefin mole ratio of from about 1 to about 1.5, and the weight percent of acid catalyst is greater than 2 wt. %

16. The process of claim 11, wherein the polyisobutylene has a Mn of from about 1500 to about 5000, the peroxide/olefin mole ratio is about 5 to about 6, the carboxylic acid/olefin mole ratio is from about 2 to about 2.5, and the weight percent acid catalyst is in the range from about 4 wt % to about 6 wt %.

17. The process of claim 11 wherein the polyisobutylene epoxide is a highly reactive polyisobutylene having between 50 mole percent to about 90 mole percent alpha-vinylidene isobutylene isomer content.

18. The process of claim 11, wherein the purified polyisobutylene epoxide indicates a greater than 93% olefin conversion and greater than 93% epoxide yield as measured by ¹H-NMR.

19. The process of claim 11, wherein the purified polyisobutylene epoxide has an number average molecular weight (Mn) of from about 400 to about 3000 and an oxirane oxygen value of from about 0.25% to about 2%.

20. The process of claim 11 wherein the carboxylic acid/olefin mole ratio is greater than 0.55 to about 4.

21. A process for epoxidizing polyisobutylene, the process comprising the steps of: (a) combining in a single reactor vessel at an ambient temperature and pressure, polyisobutylene olefin having a number average molecular weight (Mn) in the range of about 400 to about 2500 with a solvent capable of solubilizing the polyisobutylene, (b) adding to the single reactor vessel a mixture of reactants comprising hydrogen peroxide, an organic carboxylic acid and a mineral acid catalyst while maintaining a reactor temperature at no more than 15° C. above the ambient temperature, wherein the hydrogen peroxide/olefin mole ratio is from about 1.5 to about 7, the carboxylic acid/olefin mole ratio is from about 0.5 to about 3, and the weight percent of acid catalyst is greater than 2 wt % to about 10 wt %; (c) heating the single reactor vessel to no more than about 80° C. for a time sufficient to form a non-aqueous phase comprising polyisobutylene epoxide and an aqueous phase; (d) cooling the single reactor vessel sufficient to separate the non-aqueous phase from the aqueous phase; (e) washing and neutralizing the non-aqueous phase to sufficiently remove and neutralize substantially all the acid remaining in the non-aqueous phase; and, (f) isolating and drying the polyisobutylene epoxide, wherein ¹H-NMR analysis indicates an olefin conversion of at least 90% and an epoxide yield of at least 90%.

22. The process of claim 21 wherein in the washing and neutralizing step (e) the non-aqueous phase has a pH of about 6.5 to about 7.5.

23. The process of claim 21, wherein in cooling step (d) the reactor temperature is cooled to about 45° C. to 50° C.

24. The process of claim 21, wherein the polyisobutylene has a Mn of from about 400 to about 1200, the peroxide/olefin mole ratio is from about 2.5 to about 3.5, the acetic acid/olefin mole ratio of from about 1 to about 1.5, and the weight percent of acid catalyst is greater than 2 wt. %

25. The process of claim 21, wherein the polyisobutylene has a Mn of from about 1500 to about 5000, the peroxide/olefin mole ratio is about 5 to about 6, the carboxylic acid/olefin mole ratio is from about 2 to about 2.5, and the weight percent acid catalyst is in the range from about 4 wt % to about 6 wt %.

26. The process of claim 21 wherein the polyisobutylene epoxide is a highly reactive polyisobutylene having between 50 mole percent to about 90 mole percent alpha-vinylidene isobutylene isomer content.

27. The process of claim 21, wherein ¹H-NMR analysis polyisobutylene epoxide in step (f) indicates an olefin conversion of at least 93% and an epoxide yield of at least 93%.

28. The process of claim 21, wherein in step (b) the temperature is maintained within 10° C. of ambient temperature.

29. The process of claim 28, wherein in step (c), the reactor vessel is heated to about 70° C. for about 2 to 3 hours.

30. The process of claim 21, wherein ¹H-NMR analysis of polyisobutylene epoxide in step (f) indicates an olefin conversion of at least 95% and an epoxide yield of at least 95%.
